(19) United States
(12) Patent Application Publication
(10) Pub. No.: US 2023/0149884 A1
(43) Pub. Date: May 18, 2023

(54) Reactor System and Method for Producing and/or Treating Particles

(71) Applicant: Glatt Ingenieurtechnik Gesellschaft mit beschränkter Haftung, Weimar (DE)

(72) Inventors: Frank Ohlendorf, Erfurt (DE); Arne Teiwes, Weimar (DE); Louis Friedrich, Bienstädt (DE); Michael Jacob, Weimar (DE)

(21) Appl. No.: 17/916,379

(22) PCT Filed: Mar. 25, 2021
(86) PCT No.: PCT/EP2021/057704

§ 371 Date: Sep. 30, 2022

(30) Foreign Application Priority Data
Mar. 31, 2020 (DE) 10 2020 204 200.4

(51) Int. Cl. B01J 19/10; B01J 19/24; B01J 19/00; B01J 2/18

(52) U.S. Cl. CPC B01J 19/10; B01J 2/18; B01J 19/0013; B01J 19/241; B01J 2219/00484; B01J 2219/0869; B01J 2219/0871; B01J 2219/0875; B01J 2219/0886

(57) ABSTRACT

A reactor system and a method for the production and/or treatment of particles in an oscillating process gas stream. The reactor system includes a reaction unit and a pulsation device. A pulsation that has a pulsation frequency and a pulsation pressure amplitude can be imposed on the process gas by means of the pulsation device. The pulsation device can adapt a pulation frequency and/or pulsation pressure amplitude of the pulsation to one of the inherent resonance frequencies of a resonator.

### CROSS-REFERENCE TO RELATED APPLICATIONS

This application is the U.S. national phase of International Application No. PCT/EP2021/057704 filed Mar. 25, 2021, and claims priority to German Patent Application No. 10 2020 204 200.4 filed Mar. 31, 2020, the disclosures of which are hereby incorporated by reference in their entireties.

### BACKGROUND

### Field

The invention relates to a reactor system for the production and/or treatment of particles in an oscillating process gas stream, having a reactor unit that has an upstream process gas feed unit and a downstream process gas discharge unit, which reactor unit has at least one reaction space for particle production and/or treatment and an application device for introducing a starting substance into the reactor that comprises the reaction space, wherein the process gas that flows through the reactor unit in the direction of the process gas discharge unit can be fed to the reactor unit by way of the process gas feed unit, and the reactor system comprises a pulsation device that is suitable for the production of a pulsation of a process gas, wherein a pulsation that has a pulsation frequency and a pulsation pressure amplitude can be imposed on the process gas by means of the pulsation device, and wherein the reactor system, which has a static process gas pressure, in particular one that can be adjusted, is configured as an acoustic resonator that has inherent resonance frequencies that define a resonance state, in each instance, and the process gas can form a gas column capable of resonance in the reactor system, so that the resonator can be excited by means of the pulsation generated by the pulsation frequency and/or the pulsation pressure amplitude that is/are generated by the pulsation device, and in the resonance state, the pulsation can be amplified to produce a resonance oscillation of the process gas that has a resonance frequency and a resonance pressure amplitude, and wherein the process gas feed unit and the process gas discharge unit each comprise a pressure loss production device that produces a pressure loss, wherein the pressure loss production devices are configured in such a manner that one of the resonance states can be optionally set.

Furthermore the invention relates to a method for the production and/or treatment of particles in an oscillating process gas stream, comprising a reactor system having a reactor unit that has an upstream process gas feed unit and a downstream process gas discharge unit, which reactor unit has at least one reaction space for particle production and/or treatment and an application device for introducing a starting substance into the reactor that comprises the reaction space, wherein the process gas that flows through the reactor unit in the direction of the process gas discharge unit is fed to the reactor unit by way of the process gas feed unit, and the reactor system comprises a pulsation device that is suitable for the production of a pulsation of a process gas, wherein a pulsation that has a pulsation frequency and a pulsation pressure amplitude is imposed on the process gas by means of the pulsation device, and wherein the reactor system, which has a static process gas pressure, in particular one that can be adjusted, is configured as an acoustic resonator that has inherent resonance frequencies that define a resonance state, in each instance, and the process gas forms a gas column capable of resonance in the reactor system, so that the resonator is excited by means of the pulsation generated by the pulsation frequency and/or the pulsation pressure amplitude that is/are generated by the pulsation device, and in the resonance state, the pulsation is amplified to produce a resonance oscillation of the process gas that has a resonance frequency and a resonance pressure amplitude, and wherein the process gas feed unit and the process gas discharge unit each comprise a pressure loss production device that produces a pressure loss, wherein the pressure loss production devices are configured in such a manner that one of the resonance states can be optionally set.

### Description of Related Art

Reactor systems and methods for the production and/or treatment of particles, preferably of fine particles having an average particle size of 1 nm to 5 mm, in particular nano-scale or nano-crystalline particles, in an oscillating process gas stream, are already known from the state of the art.

Reactor systems configured as acoustic resonators are known, in which an oscillation or pulsation of the process gas is used, with the purpose of producing a resonance oscillation, wherein the latter has an influence, in particular, on acoustic, material (in the case of multi-phase systems, for example) and heat-technology properties (influencing heat transfer, for example), in that the resonance oscillation of the process gas has an effect, in the form of mechanical forces and/or in the form of a change in dwell time, on the solid and/or liquid particles to be produced and/or treated in the process gas, and can be usefully applied for various purposes. Such acoustic resonators are, for example, hollow cavity resonators, in particular Helmholtz resonators, which have inherent resonance frequencies that define a resonance state, in each instance. In this regard, the resonance oscillation can be produced in different ways and can be influenced with regard to its resonance frequency and resonance pressure amplitude.

For the quality of the resonance oscillation in a reactor system, a decisive role is played essentially by the manner of production of the resonance oscillation, the geometry of the reactor system in which the resonance oscillation is to be made usable, the ability to regulate the resonance frequency and/or the resonance pressure amplitude in the reactor system, the material properties of the process gas, which are determined, among other things, by the temperature and the static pressure of the process gas, as well as by the retroactive effects on the reactor system itself.

The German patent application DE 10 2015 005 224 A1 discloses a method for targeted setting and regulation of the amplitudes of the oscillations of the static pressure and/or of the hot gas velocity in a pulsating jet system with or without thermal material treatment / material synthesis, which has at least one burner with which an oscillating (pulsating) flame is produced, and at least one combustion space (resonator), into which the flame is directed. Usually targeted, independent adjustment of the amplitude (oscillation intensity) of the pulsating hot gas stream that results from self-excited, feedback-coupled combustion instability in a pulsating jet furnace or a pulsation reactor is not possible, and therefore neither is an adaptation of the periodic non-stationary combustion process to the selected throughput of the reactor (in the case of material treatment / material synthesis: for example the educt application rate or the product rate), without a simultaneous but non-desired change in other process parameters (treatment temperature, dwell time or treatment duration) and thereby also of the material properties that are produced. In order to make this possible nevertheless, it is proposed to insert an oscillation volume through which air, fuel or a fuel/air mixture flow upstream from the burner outlet, into supply lines of the burner that run to the burner. Preferably the size of this volume can be infinitely adjustable.

In this way, it is possible to change the amplitude of the oscillation.

The German patent application DE 10 2015 006 238 A1 shows a method and an apparatus for thermal material treatment or material conversion, in particular of coarse, granular raw materials, in a pulsating hot gas stream having an independently adjustable frequency and amplitude of the velocity oscillation or the static pressure oscillation of the hot gas stream in a vertically arranged reaction space. Raw material particles that are introduced at the upper and of the vertically arranged reaction space cannot be pneumatically transported by the hot gas stream when an average flow speed of the stream is set, because of their shape, mass, and density, but rather sink down counter to the flow direction. During this sinking time of approximately 1 s to 10 s, thermal treatment of the material to produce the desired product takes place, and the latter is removed from the reactor at the lower end of the reaction pipe, using a gateway system.

A method and an apparatus for thermal treatment of a raw material, having a combustion chamber in which a periodically non-stationary, oscillating flame is burning, for the production of a pulsating exhaust gas stream that flows through a reaction space that follows the combustion chamber, is disclosed in the German patent application DE 10 2016 002 566 A1. In order to achieve the result that the raw material is efficiently treated, it is proposed that an insert that has a cross-sectional surface area that is reduced in size as compared with the reaction space and through which the exhaust gas flows is provided in the reaction space, which insert has a length that is shorter than a total length of the reaction space. In particular, the length of the insert and the geometry of the combustion chamber can be changed, so that the apparatus has two resonators that can be coordinated with one another.

The German patent application DE 10 2018 211 650 A1 relates to an apparatus for the production of particles, in particular of fine, in particular nano-scale or nano-crystalline particles, from at least one raw material. In this regard, the apparatus comprises at least one burner and a combustion chamber that follows the burner, to generate a pulsating hot gas stream, a reaction space section that follows the burner, and at least one pressure arrangement for setting a resonance behavior and thereby the acoustic pressure within the combustion chamber and/or within the reaction space section.

### SUMMARY

The technical solutions known from the prior art all have the disadvantage that the resonance frequency and/or the resonance pressure amplitude of the resonance oscillation of the process gas can be changed exclusively by means of an adaptation of the geometric dimensions of the reactor system, which is configured as an acoustic resonator, and thereby also of the process gas volume of the gas column that is capable of resonance and formed in the reactor system.

It is therefore the task of the invention to make available both a reactor system and a method for the production and/or treatment of particles in an oscillating or pulsating process gas stream, which system or method makes it possible to set the resonance frequency and/or the resonance pressure amplitude of the resonance oscillation of the process gas, independent of the geometric dimensions of the reactor system, which is configured as an acoustic resonator, and thereby independent of the process gas volume of the gas column that is formed in the reactor system and is capable of resonance.

This task is accomplished, in the case of a reactor system of the type stated initially, in that the pulsation device is configured for adapting the pulsation frequency and/or the pulsation pressure amplitude of the pulsation to one of the inherent resonance frequencies of the resonator, so that the selected resonance state can be achieved. By means of this targeted adaptation of the pulsation frequency and/or the pulsation pressure amplitude of the pulsation by means of the pulsation device, it is possible to excite the system of the resonator, which is capable of oscillating, and thereby to improve the heat and material transfer properties of the preferably hot process gas in the reactor system.

The additional pressure loss brought about by the pressure loss production device as a function of the acoustic properties of the resonator in the oscillating system then corresponds to the resonance pressure amplitude of the resonance oscillation of the process gas that was excited by the pulsation device. The pressure loss production devices limit the oscillating system of the reactor system in the operating state geometrically and with regard to the process gas volume of the gas column that is formed and is capable of resonating. In this way, it is possible to impose a pulsation, by means of the pulsation device, onto the process gas while the geometric dimensions of the oscillating system of the reactor system remain the same, and therefore the process gas volume of the gas column that is formed and is capable of resonating also remains the same in the reactor system, and thereby the oscillating system in the reactor system is excited and the pulsation is amplified to produce a resonance oscillation of the process gas that has a resonance frequency and a resonance pressure amplitude.

The essence of the pressure loss production device therefore consists of limiting the reactor system in terms of the geometric dimensions, allowing a process gas stream through the reactor system, and, at the same time, preventing the propagation of the resonance oscillation beyond the pressure loss production device, and thereby forming a defined system, capable of oscillation, within the reactor system. The more limited the oscillating system is, the more effective production and propagation of the resonance oscillation in the oscillating system will be. By means of the defined system, capable of oscillation, it is made possible for excitation and propagation of the resonance oscillation, with regard to its resonance frequency and/or resonance pressure amplitude, to be produced and adjusted with reasonable technical effort and expenditure of energy, in a continuous, in particular periodic manner.

In accordance with an advantageous embodiment of the reactor system in this regard, the pulsation device is configured as a pulsation device that works without a flame. Preferably the pulsation device is configured as a compression module, in particular as a piston, or as a rotary vane or as a modified turnstile. A pulsation device that works without a flame is characterized in that the pulsation device is not based on a combustion process that imposes a pulsation on the process gas. In particular, the pulsation is not produced on the basis of a pulsating process gas stream of a periodically non-stationary combustion process that results from a self-excited, feedback-coupled combustion instability. As a result, it is possible – in contrast to a pulsation device based on the combustion process –to adjust or adapt the pulsation frequency and/or the pulsation pressure amplitude, and to excite any desired, defined system that is capable of oscillation, to produce a resonance oscillation.

It is furthermore advantageous that the reactor system can be operated with any desired process gas or process gas mixture. Preferably the gases that are used as a process gas are suitable, for example, for reduction operation or as an explosion-protection gas. In a particularly preferred embodiment, the process gas is an inert gas, i.e., the process gas does not participate in the reaction for the production and/or treatment of the particles that takes place in the reactor, but rather serves to make available and transfer the heat energy, and also as a transport gas for the particles. It is furthermore very advantageous with regard to the aforementioned embodiments that the reactor system is suitable not only for the “traditional” inorganic starting substances but also for organic and/or combustible starting substances.

Furthermore, no fuel gas is required during operation of the reactor system, so that contamination-minimized production and/or treatment of particles, going as far as contamination-free production and/or treatment of particles can take place. By means of minimizing or avoiding contamination in the production and/or treatment of the particles, preferably of nanoparticles, particularly preferably of nano-crystalline metal oxide particles, in accordance with the preferred method, the possibility exists of producing highly pure particles. Furthermore, a simplified system and safety concept is sufficient for the reactor system, due to the possibility that no fuel gas is required, because no flame monitoring has to be set up, for example. The possibility exists of adapting the production and/or treatment process in such a manner that the reactor system is suitable for pharmaceutical production processes and production processes in the food industry.

According to an advantageous further development of the reactor system, the reactor system has a heating device for heating the process gas. Preferably the heating device is configured as a convection heater, an electric gas heater, a plasma heater, a microwave heater, an induction heater, a radiation heater or a gas-fired heater, for example as a burner.

The heating device can be arranged upstream or downstream from the pulsation device. Placement upstream from the pulsation device is preferred, since in such an arrangement, the heating device does not damp the resonance pressure amplitude in the reactor system. Furthermore, the heating device is suitable for heating the process gas to temperatures of 100° C. to 3000° C., preferably to temperatures of 240° C. to 2200° C., particularly preferably to temperatures of 240° C. to 1800° C., very particularly preferably to temperatures of 650° C. to 1800° C., most preferably to temperatures of 700° C. to 1500° C. The very great temperature range from 100° C. to 3000° C. allows effective and individual adaptation to the production and/or treatment process of the particles. In comparison with a reactor system that is based on a combustion process in accordance with the state of the art, clearly lower process temperatures are very efficiently possible, i.e., without an additional air feed.

According to an additional advantageous embodiment of the reactor system, the pressure loss production devices are arranged in the process gas feed unit and the process gas discharge unit, in their corresponding position in the operating state, in an unchangeable manner. It is advantageous that the unchangeable placement of the pressure loss production devices in the operating state achieves a system that is capable of oscillation in the reactor system, which system has precisely defined geometric dimensions and thereby a defined process gas volume, and a gas column that is formed in the reactor system and capable of resonance. On the basis of the system that oscillates within limits, efficient production and propagation of the resonance oscillation in the oscillating system is possible.

Preferably the pulsation device is configured as a pressure loss production device. By means of the configuration of the pulsation device as a pressure loss production device, a system component is saved, and thereby the investment costs are lowered.

In accordance with a further advantageous further development of the reactor system, a gas volume stream regulation device is arranged upstream from the at least one reactor. Preferably the process gas volume stream regulation device is arranged downstream from the pulsation device. The process gas volume stream regulation device is configured, in this regard, in particular as a sliding gate valve, regulating valve, regulating cock or an iris shutter that can be regulated. Regulating fittings that demonstrate great regulation precision are suitable as a process gas volume stream regulation device. It is practical if the process gas volume stream regulation device has a regulation precision of less than or equal to 3 %, preferably of less than or equal to 2 %, particularly preferably of less than or equal to 1 %, and most preferably of less than or equal to 0.5 %. A process gas volume stream regulation that demonstrates great regulation precision is necessary so as to minimize or prevent feedback to the process gas volume stream caused by the resonance oscillation. In particular, great regulation precision values of the process gas volume stream are necessary when using a process gas stream divider device, so that the system, which is capable of oscillation and/or oscillates in the operating state can be operated in a stable manner.

According to an additional advantageous embodiment of the reactor system, a process gas stream divider device is arranged upstream from the at least one reactor, so that at least one process gas feed line is assigned to each reactor of the reactor unit. Preferably each process gas feed line has a process gas volume stream regulation device. Particularly preferably the process gas stream divider device is arranged downstream from the pulsation device. Each process gas feed line is configured, in particular, in such a manner that each process gas line has a pressure loss between the process gas stream divider device and a reactor process gas inlet, wherein the pressure loss is essentially equally great in each process gas line. For this purpose, it is practical if the process gas feed lines furthermore have the same process gas feed line length and/or the same process gas feed line inside diameter and/or other fittings that are the same. By means of the aforementioned measures, uniform distribution of the partial process gas streams of the process gas feed lines is brought about.

According to an additional advantageous further development of the reactor system or of the method, the process gas feed unit and the process gas discharge unit have a process gas pressure regulation device, so that the static process gas pressure in the reactor system can be set or regulated. It is particularly advantageous, in this regard, that the reactor system can be operated at different, optional static process gas pressures. By means of the adaptation of the static process gas pressure, the acoustic properties of the reactor system can be influenced, so that the reactor system can be adapted, for example, to application of different starting substances that damp the resonance pressure amplitude of the resonance oscillation. In this way, it is additionally possible to influence the resonance pressure amplitude independently of the process temperatures, and to influence the effect on the production or treatment of the particles, preferably to amplify it. The static process gas pressure can be set to be in the partial vacuum range or in the excess pressure range with regard to the environment. An increase in the static process gas pressure generally leads to an amplification of the resonance pressure amplitude. The change in the properties of the resonator as a function of the static process gas pressure is significant.

Furthermore, the process gas discharge device preferably has a plurality of process gas drain lines, wherein each process gas drain line has a pressure loss production device. In this way, the system capable of oscillation, of the reactor system, is advantageously limited in terms of its geometric dimensions.

According to an additional advantageous embodiment of the reactor system, the process gas discharge device has a process gas cooling segment and/or a separation device, in particular a cyclone and/or a filter, and/or a process gas conveying device. The process gas cooling segment serves to stop the reactions that are taking place and/or to adapt the process gas stream to a maximally permissible temperature of a subsequent deposition device, in particular a filter; for example, a quencher is also used for this purpose, which allows rapid stopping of the reactions that are taking place, at a specific location and thereby also time point of the reaction. The separation device, which can have filter devices that comprise multiple filters, for example so as to increase the separation surface area, serves for separating the particles from the process gas.

In the case of a method of the type stated initially, the task is thereby accomplished that the pulsation frequency and/or the pulsation pressure amplitude of the pulsation is/are adapted to one of the inherent resonance frequencies of the resonator by means of the pulsation device, so as to achieve the selected resonance state. Preferably a periodic pulsation is imposed on the process gas. Particularly preferably, the pulsation frequency or a whole-number multiple of it is set close to the resonance frequency of the resonator, so that the resonator is excited and a resonance oscillation occurs in the system that is capable of oscillation. By imposing a periodic pulsation on the process gas, wherein the pulsation frequency or a whole-number multiple of it is set close to the resonance frequency of the resonator, amplification of the one resonance frequency and a resonance oscillation of the process gas, which oscillation has a resonance pressure amplitude, is achieved. Close to it means here that the pulsation frequency or a whole-number multiple of it has a frequency that lies in the range of ± 5 % of the resonance frequency.

Therefore, it is no longer the case, as is usual in the state of the art, that the reactor system, which is configured as a resonator, is adapted to the pulsation that has a pulsation frequency and/or a pulsation pressure amplitude, but rather the pulsation is adapted to the resonator, which has a system capable of oscillation, so as to achieve the selected resonance state of the acoustic resonator. The resonator properties can be changed independently of the process temperatures, by means of changing the static process gas pressure. It is advantageous that it is now possible to use the same reactor system for the production and/or treatment of different particles, by means of adapting the pulsation.

In accordance with an advantageous embodiment of the method, the process gas flows through the reactor system with a dwell time of 0.1 s to 25 s. On the basis of a longer dwell time in the reactor system and thereby also in the reactor, the starting substances are exposed to the process gas temperature longer, and thereby the particle production and/or treatment can be completed without having to subject the particles to subsequent thermal treatment, for example.

Furthermore, a pulsation frequency of 1 Hz to 2000 Hz is imposed on the process gas by means of the pulsation device, preferably between 1 Hz to 500 Hz, particularly preferably between 40 Hz and 160 Hz. It is advantageous that in this way the result is achieved that by means of the possibility of setting a broad frequency range, very high degrees of turbulence are achieved in the process gas that flows through the reactor system, and thereby very small particles, down to the nano-scale range, can be produced, which can be adapted precisely to the particles to be treated and produced. By means of the increase in the degree of turbulence, the material transfer and heat transfer in the reactor system, between process gas and at least one starting substance to be thermally treated, is clearly improved.

According to an additional advantageous further development, a pulsation pressure amplitude von 0.1 mbar to 350 mbar, particularly preferably of 1 mbar to 200 mbar, very particularly preferably of 3 mbar to 50 mbar, most preferably of 10 mbar to 40 mbar is imposed on the process gas by means of the pulsation device. By means of the pressure pulsation that is imposed, having a defined pressure amplitude, it is possible to optimally set the process conditions required for the particles that are to be produced and/or treated.

In a particularly preferred embodiment of the method, a pulsation frequency of 40 Hz to 160 Hz and a pulsation pressure amplitude of 10 mbar to 40 mbar is imposed on the process gas by means of the pulsation device. These conditions have surprisingly proven to be the optimal combination of pulsation frequency and pulsation amplitude, at which the material transfer and heat transfer in the reactor system, between process gas and particles to be thermally treated, is very good.

Furthermore, the pressure loss production devices are not changed in terms of their respective positions in the operating state. It is advantageous that in this way, in the operating state, the geometric dimensions of the reactor system and thereby also the process gas volume of the gas column formed in the reactor system, which column is capable of resonance, are not changed, so that the pulsation can be optimally adapted to the method, which is carried out with a specific starting substance. A further advantage is that after completion of a method, the pressure loss production devices can be changed in terms of their respective positions, and the reactor system can thereby be adapted to other methods to be carried out.

Furthermore, the reactor system used for the method is a reactor system for the production and/or treatment of particles in an oscillating process gas stream, having a reactor unit that has an upstream process gas feed unit and a downstream process gas discharge unit, which reactor unit has at least one reaction space for particle production and/or treatment and an application device for introducing a starting substance into the reactor that comprises the reaction space, wherein the process gas that flows through the reactor unit in the direction of the process gas discharge unit can be fed to the reactor unit by way of the process gas feed unit, and the reactor system comprises a pulsation device that is suitable for the production of a pulsation of a process gas, wherein a pulsation that has a pulsation frequency and a pulsation pressure amplitude can be imposed on the process gas by means of the pulsation device, and wherein the reactor system, which has a static process gas pressure, in particular one that can be adjusted, is configured as an acoustic resonator that has inherent resonance frequencies that define a resonance state, in each instance, and the process gas can form a gas column capable of resonance in the reactor system, so that the resonator can be excited by means of the pulsation generated by the pulsation frequency and/or the pulsation pressure amplitude that is/are generated by the pulsation device, and in the resonance state, the pulsation can be amplified to produce a resonance oscillation of the process gas that has a resonance frequency and a resonance pressure amplitude, and wherein the process gas feed unit and the process gas discharge unit each comprise a pressure loss production device that produces a pressure loss, wherein the pressure loss production devices are configured in such a manner that one of the resonance states can be optionally set, wherein the pulsation device is configured for adapting the pulsation frequency and/or the pulsation pressure amplitude of the pulsation to one of the inherent resonance frequencies of the resonator, so that the selected resonance state can be achieved.

### BRIEF DESCRIPTION OF THE DRAWINGS

In the following, the invention will be explained in greater detail using the attached drawing, which shows:

FIG. 1 a schematic representation of a first embodiment of a preferred reactor system,

FIG. 2 a schematic representation of a second embodiment of a preferred reactor system,

FIG. 3 a schematic representation a third embodiment of a preferred reactor system,

FIG. 4 a schematic representation a fourth embodiment of a preferred reactor system,

FIG. 5 a schematic representation of a fifth embodiment of a preferred reactor system, and

FIG. 6 a diagram of the resonance pressure amplitude plotted above the resonance frequency at three different positions in the reactor system.

### DETAILED DESCRIPTION

If no information to the contrary is stated, the following description relates to all the embodiments of a reactor system 1 illustrated in the drawing, for the production and/or treatment of particles P in an oscillating process gas stream.

The reactor system 1 has a reactor unit 2, which is preceded by a process gas feed unit 3 and followed by a process gas discharge unit 4.

The reactor system 1 comprises a process gas conveying device 5 and a heating device 6. The process gas PG that flows through the reactor system 1 enters into the reactor system 1 by way of the process gas feed unit 3, and is conveyed through the reactor system 1 by means of the process gas conveying device 5.

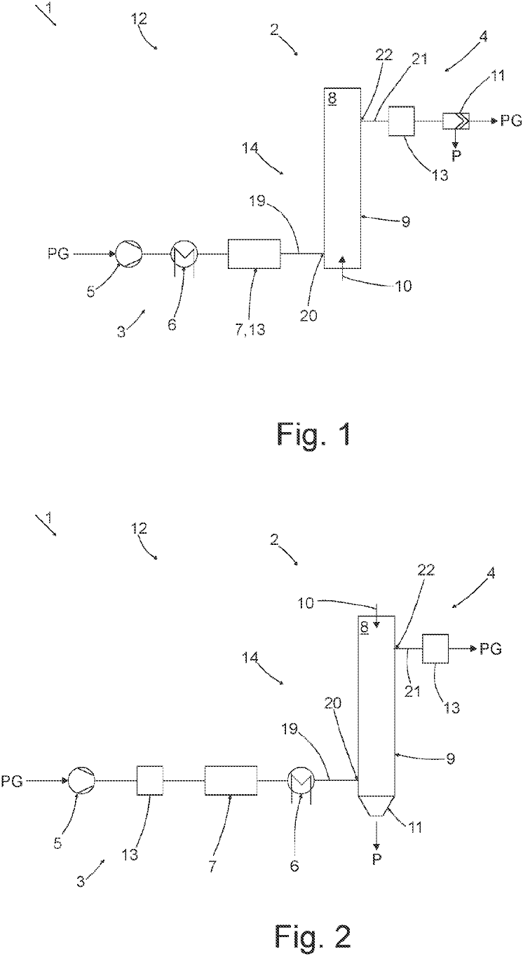

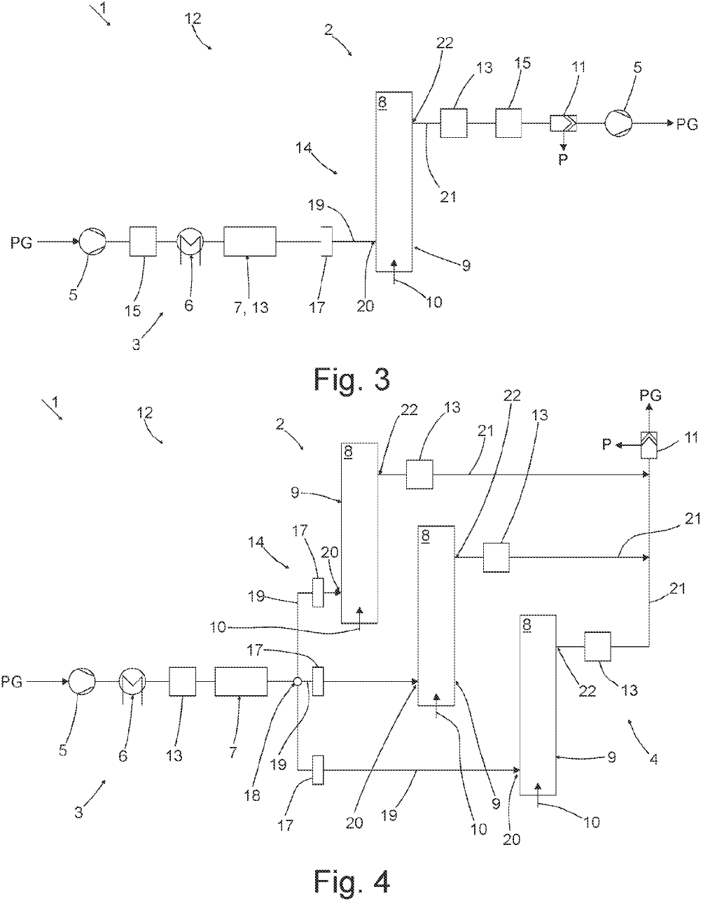

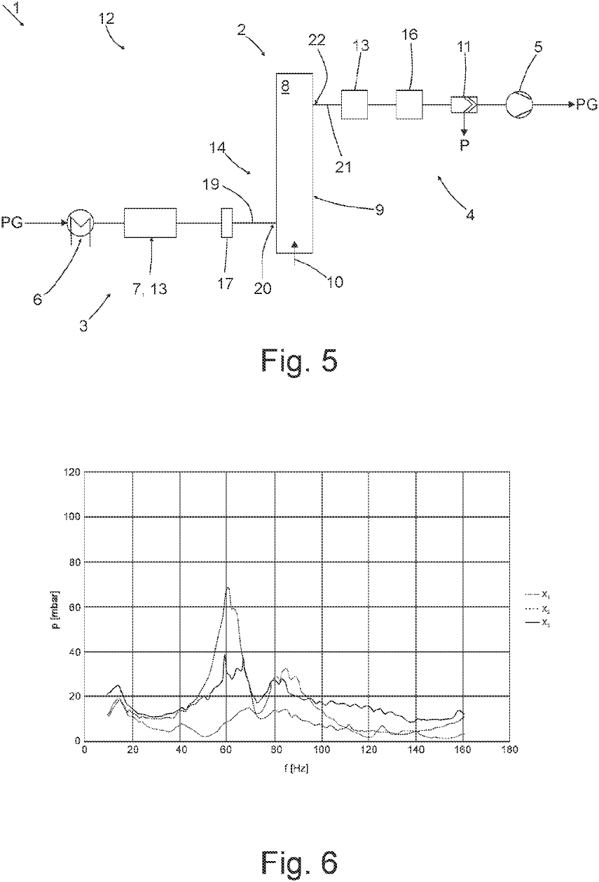

The process gas conveying device 5 is configured, for example, in particular as a radial ventilator, blower or compressor. The process gas conveying device 5 can be arranged, in particular, in the process gas feed unit 3, the process gas discharge unit 4 or alternatively both in the process gas feed unit 3 and in the process gas discharge unit 4. In the embodiments of FIGS. 1, 2, and 4, placement of the process gas conveying device 5 in the process gas feed unit 3 is shown; in FIG. 5 the process gas discharge unit 4 has the process gas conveying device 5. FIG. 3 represents an embodiment having two process gas conveying devices 5, which are arranged both in the process gas feed unit 3 and also the process gas discharge unit 4. The placement of the process gas conveying device 5 is adapted to the conditions to be set in the reactor system 1, in particular with regard to shape, mass, and density of the starting substance.

The heating device 6 can be arranged upstream or downstream from a pulsation device 7. Placement upstream from the pulsation device 7 - for example as shown in the embodiments of FIGS. 1, 2, 3, and 5 - is preferred, since in the case of such an arrangement, the heating device 6 does not damp a resonance pressure amplitude in the reactor system 1. Placement downstream from the pulsation device 7 is disclosed in the embodiment shown in FIG. 2. The placement of the heating device 6 decides the assignment of the heating device 6 to the reactor unit 2 or to the process gas feed unit 3. A heating device 6 arranged upstream from the pulsation device 7 is assigned to the process gas feed unit 3, a heating device 6 arranged downstream from the pulsation device 7 is assigned to the reactor unit 2.

Preferably the heating device 6 is configured as a convective gas heater, an electric gas heater, a plasma heater, a microwave heater, an induction heater or a radiation heater. It is less preferred for the heating device 6 to be configured as a burner that has a flame.

The process gas PG that flows through the reactor system 1 is warmed or heated to a production and/or treatment temperature by means of the heating device 6. The temperature for the production or thermal treatment of the at least one starting substance preferably lies between 100° C. and 3000° C., preferably at 240° C. to 2200° C., particularly preferably at 240° C. to 1800° C., very particularly preferably at 650° C. to 1800° C., most preferably at 700° C. to 1500° C.

A pulsation having a pulsation frequency and a pulsation pressure amplitude is imposed on the process gas PG that flows through the reactor system 1 by means of the pulsation device 7. The pulsation preferably has a pulsation pressure amplitude of 0.1 mbar to 350 mbar, particularly preferably of 1 mbar to 200 mbar, very particularly preferably of 3 mbar to 50 mbar, most preferably of 10 mbar to 40 mbar.

The pulsation frequency of the process gas PG can be set independently of the pulsation pressure amplitude. The pulsation frequency of the process gas PG that flows through the reactor system 1, pulsating due to the pulsation device 7, can also be adjusted, preferably in the frequency range of 1 Hz to 2000 Hz, preferably between 1 Hz to 500 Hz, particularly preferably between 40 Hz and 160 Hz.

The pulsation device 7 is configured as a pulsation device 7 that works without a flame. It is practical if the pulsation device 7 is configured as a compression module, in particular as a piston, or as a rotary vane or as a modified turnstile.

The reactor 9, which has a reaction space 8 and is assigned to the reactor unit 2, is formed downstream from the process gas feed unit 3. In the reaction space 8 of the reactor 9, a pulsating process gas PG that flows through the reactor system 1 and the reactor 9 is introduced into the starting substance by means of an application device 10.

The application device 10 is preferably configured for introduction of liquids or solids into the reaction space 8 of the reactor 9.

Liquids or liquid raw materials (precursors) can be introduced into the reaction space 8 preferably as a solution, suspension, melt, emulsion or as a pure liquid. The introduction of the liquid raw materials or liquids preferably takes place continuously. For the introduction of liquids into the reaction space 8 of the reactor 9 of the reaction unit 2, an application device 10 is preferably used, such as, for example, spray nozzles, feed pipes or droplet dispensers, which are configured, for example, as single-substance or multi-substance nozzles, pressure nozzles, nebulizers (aerosol) or ultrasound nozzles.

In contrast to this, for the introduction of solids, for example powders, granulates or the like, into the reactor 9, preferably into the reaction space 8 of the reactor 9, an application device 10 is preferably used, such as, for example, a double flap, a rotary feeder, a batching valve or an injector.

The introduction of the starting substance in the form of a liquid or of a solid can take place in or counter to the flow direction of the process gas PG that flows through the reactor system 1. In the embodiments of FIGS. 1 and 3 to 5, application of the starting substance takes place in the flow direction of the process gas; in the embodiment shown in FIG. 2, application of the starting substance takes place counter to the flow direction of the process gas.

Preferably the starting substance is introduced into the reactor system 1, preferably into the reaction space 8 of the reactor 9, using a carrier gas. The decision as to whether the starting substance is introduced into the reactor system 1 in or counter to the flow direction of the process gas depends decisively on the shape, mass, and density of the starting substance at a set average flow speed of the process gas PG. As a result, the possibility exists of also thermally treating starting substances that cannot be transported in the reactor system 1 by means of the process gas PG.

The starting substance is treated thermally in the treatment zone of the reactor 9, preferably in the reaction space 8, so that the particles P to be produced, preferably the inorganic or organic nano-particles, particularly preferably the nano-crystalline metal oxide particles, are formed. The region in which the starting substances are treated thermally is defined as the treatment zone.

The process gas discharge unit 4 that follows the reaction unit 2 comprises a separation device 11. The separation device 11, in particular a filter, preferably a hot gas filter, very particularly preferably a tubular, metal or fiberglass filter, a cyclone or a washer, separates the thermally treated particles P from the pulsating, hot process gas stream that flows through the reactor system 1. The particles P that are removed from the process gas stream are drawn off from the separation device 11 and processed further. If necessary, the particles P that have been thermally treated in the reactor system 1 are subjected to further subsequent treatment steps, such as, for example, suspension, grinding or calcination. The non-charged process gas PG is conducted away into the environment.

The dwell time of the one starting substance introduced into the reactor system 1, in particular into the reaction space 8 of the reactor 9, lies between 0.1 s and 25 s. Closed-cycle operation of the process gas PG is possible. If applicable, partial removal of the process gas PG from the circuit is also possible.

Furthermore, the reactor system 1, which has a static process gas pressure, is configured as an acoustic resonator 12, which has inherent resonance frequencies that each define a resonance state. The process gas PG can form a gas column that is capable of resonance in the reactor system 1, so that the resonator 12 can be excited by means of the pulsation frequency and/or the pulsation pressure amplitude of the pulsation that is generated by means of the pulsation device 7, and in the resonance state, the pulsation can be amplified to produce a resonance oscillation of the process gas PG that has a resonance frequency and a resonance pressure amplitude.

The process gas feed unit 3 and the process gas discharge unit 4 each comprise a pressure loss production device 13 that produces a pressure loss, wherein the pressure loss production devices 13 are configured in such a manner that optionally one of the resonance states of the resonator 12 can be set. The pressure loss production devices 13 limit a system 14 of the reactor system 1 that is capable of oscillation and oscillates in the operating state, geometrically and with regard to the process gas volume of the gas column that is formed and is capable of resonance. The pressure loss production devices 13 thereby prevent propagation of the resonance oscillation beyond the pressure loss production devices 13. The more limited the system 14 is, which is capable of oscillation or oscillates in the operating state, the more effective production and propagation of the resonance oscillation in the system 14 will be.

The pulsation device 7 is preferably configured as a pressure loss production device 13. Such a preferred embodiment of the pulsation device 7 is shown in the embodiments of FIGS. 1, 3, and 5.

The pressure loss production devices 13 are arranged in the reactor system 1, in particular in the process gas feed unit 3 and the process gas discharge unit 4, so that their respective positions can be changed, wherein in the operating state, the pressure loss production devices 13 cannot be changed in terms of the position that has previously been set. In this way, it is ensured that the system 14, which oscillates in the operating state, does not change.

The pulsation device 7 of the reactor system 1 is configured for adapting the pulsation frequency and/or the pulsation pressure amplitude of the pulsation to one of the inherent resonance frequencies of the resonator 12, in such a manner that the selected resonance state can be achieved. Particularly preferably, the pulsation frequency or a whole-number multiple of it is set close to the resonance frequency of the resonator 12, so that the resonator 12 is excited and a resonance oscillation occurs in the system 14, which is capable of oscillation. By means of imposing a periodic pulsation onto the process gas, wherein in particular the pulsation frequency or a whole-number multiple of it is set close to the resonance frequency of the resonator 12, in a targeted manner, amplification of the resonance oscillation of the process gas, which has a resonance frequency and a resonance pressure amplitude, is achieved. In this way, the heat transfer and material transfer properties of the preferably hot process gas in the reactor system 1 are improved.

In the case of certain processes, it is advantageous to be able to set or regulate the static pressure in the reactor system 1. For this purpose, the reactor system 1, in particular the process gas feed unit 3 and the process gas discharge unit 4, has/have a process gas regulation device 15. The embodiment of FIG. 3 discloses such an arrangement.

The pressure loss production devices 13 that limit the system 14, which is capable of oscillation or oscillates in the operating state, are arranged within the process gas regulation device 15. Upstream from the reactor unit 2, the process gas regulation device 15 is therefore arranged upstream from the pressure loss production devices 13, and downstream from the reactor unit 2, it is arranged downstream from the pressure loss production devices 13. Without such a process gas regulation device 10, the static process gas pressure in the reactor system 1 corresponds to atmospheric pressure.

By means of adapting the static process gas pressure in the reactor system 1, an influence can be exerted on the properties of the acoustic resonator 12. Flow resistances, acoustic phenomena, and changes in the material properties of the process gas as well as of the starting substance applied to it can damp the resonance oscillation. The energy expenditure for resonance oscillation production is accordingly increased and/or the ability to regulate the resonance oscillation is influenced. In particular, the reactor system 1 can be adapted, in this way, to the factors that damp the resonance pressure amplitude of the resonance oscillation.

A higher static process gas pressure changes the acoustic properties of the resonator 12, for example to the effect that its inherent resonance frequencies shift. For this reason, excitation of the reactor system 1 is possible only by means of the imposition of other pulsation frequencies onto the process gas.

In addition, the pulsation pressure amplitude imposed on the process gas by means of the pulsation device 7, and thereby also the resonance pressure amplitude in the resonance state is amplified.

In addition, the reactor system 1 can also comprise a process gas cooling segment 16, shown in FIG. 5, for example, in particular a quenching apparatus, which is used to stop the reaction taking place in the reactor system 1 at a certain point in time and/or to adapt the process gas stream to a maximally permissible temperature of a subsequent separation device 11, in particular a filter. The process gas cooling segment 16, preferably the quenching apparatus, is arranged, here, in the process gas discharge unit 4, upstream from the separation device 11 that is configured as a filter.

To stop the reaction and/or to limit the temperature of the process gas stream to a maximally permissible temperature of a subsequent separation device 11, a cooling gas is mixed into the pulsating, hot process gas stream that flows through the reactor system 1, by way of the process gas cooling segment 16, preferably air, particularly preferably cold air or compressed air. The air mixed in by way of the process gas cooling segment 16 can be filtered or conditioned beforehand, if necessary, depending on the requirements. Furthermore, it is possible, alternatively to mixing in air or gas, to undertake injection of an evaporating liquid, for example of solvents or liquefied gases, but preferably of water.

The quenching apparatus 16 arranged in the reactor system 1 can have fittings or is built into the reactor system 1 without fittings. Other gases, such as, for example, nitrogen (N₂), argon (Ar), other inert gases or noble gases or the like can also be used as a cooling gas.

Furthermore, it can be practical if a process gas volume stream regulation device 17 is arranged upstream from the at least one reactor 9. The embodiments of FIGS. 3, 4, and 5 show process gas volume stream regulation devices 17. Preferably the process gas volume stream regulation device 17 is arranged downstream from the pulsation device. The process gas volume stream regulation device 17 is configured, in particular, as a sliding gate valve, regulating valve, regulating cock or an iris shutter that can be regulated. The process gas volume stream regulation device 17 has a regulation accuracy of less than or equal to 3 %, preferably of less than or equal to 2 %, particularly preferably of less than or equal to 1 %, and most preferably of less than or equal to 0.5 %. The process gas volume stream regulation 17, which demonstrates great regulation accuracy, is necessary so as to minimize or prevent feedback to the process gas volume stream caused by the resonance oscillation. In particular, great regulation precision of the process gas volume stream is necessary when using a process gas stream divider device 18, so that the system 14, which is capable of oscillation or oscillates in the operating state can be operated in a sufficiently stable manner.

If the reactor unit 2, as shown in the embodiment of FIG. 4, has a plurality of reactors 9, a process gas stream divider device 18 is arranged upstream from the reactors 9, so that at least one process gas feed line 19 is assigned to each reactor 9 of the reactor unit 2.

Preferably the process gas stream divider device 18 is arranged downstream from the pulsation device 7, and each process gas feed line 19 has a process gas volume stream regulation device 17. Each process gas feed line 19 is configured in such a manner that each process gas feed line 19 has a pressure loss between the process gas stream divider device 18 and a reactor inlet 20, wherein the pressure loss in each process gas feed line 19 is essentially the same. This result is achieved in that in particular the process gas feed lines 19 have the same process gas feed line length and/or the same process gas feed line inside diameter and/or other fittings that are the same.

Furthermore, the process gas discharge device 4 has a plurality of process gas discharge lines 21 that at least corresponds to the plurality of reactors 9, wherein each process gas discharge line 21 has a pressure loss production device 13.

The process gas discharge lines 21 are brought together, and the particles P are separated from the process gas stream, preferably from the hot process gas stream by way of the separation device 11.

FIG. 6 shows a diagram of the resonance pressure amplitude plotted above the resonance frequency at three different positions in the reactor system 1 at a process gas temperature of 300° C.

The curves x₁ to x₃ show the progression of the resonance pressure amplitude in the unit mbar at three different positions in the reactor system 1, namely directly after the pulsation device 7 (x₁) , at the reactor inlet 20 (x₂), and at the reactor outlet 22 (x₃) .

The resonance oscillation corresponds to an amplified pulsation, so that the pulsation frequency and the resonance frequency agree.

The pulsation pressure amplitude was set at approximately 15 mbar, as can be read from the average pulsation pressure amplitude directly after the pulsation device 7, wherein this amplitude varies minimally with a different pulsation frequency in the system 14.

From the diagram, it is possible to read 60 Hz as the inherent resonance frequency of the resonator 12, since here the greatest resonance pressure amplitude of about 70 mbar occurs at the reactor inlet 20.

At the reactor outlet 22, a resonance pressure amplitude of about 35 mbar can be read at the inherent resonance frequency of 60 Hz. The reduction in the resonance pressure amplitude between reactor inlet 20 and reactor outlet 22 can be explained by the damping of the system 14, because the application of the application substance, for example, as well as flow resistances damp the resonance pressure amplitude of the system 14.

1. A reactor system for the production and/or treatment of particles in an oscillating process gas stream, the reactor system comprising:
a reactor unit that has an upstream process gas feed unit and a downstream process gas discharge unit, which reactor unit has at least one reaction space for particle production and/or treatment and an application device for introducing a starting substance into the reactor that comprises the reaction spacer, wherein the process gas that flows through the reactor unit in the direction of the process gas discharge unit can be fed to the reactor unit by way of the process gas feed unit,
wherein the reactor system further comprises a pulsation device that is suitable for the production of a pulsation of a process gas, wherein a pulsation that has a pulsation frequency and a pulsation pressure amplitude can be imposed on the process gas by means of the pulsation device, and
wherein the reactor system, which has a static process gas pressure , is configured as an acoustic resonator that has inherent resonance frequencies that define a resonance state, in each instance, and the process gas can form a gas column capable of resonance in the reactor system, so that the resonator can be excited by means of the pulsation generated by the pulsation frequency and/or the pulsation pressure amplitude that is/are generated by the pulsation device, and in the resonance state, the pulsation can be amplified to produce a resonance oscillation of the process gas that has a resonance frequency and a resonance pressure amplitude,
wherein the process gas feed unit and the process gas discharge unit each comprise a pressure loss production device that produces a pressure loss, wherein the pressure loss production devices are configured in such a manner that one of the resonance states can be optionally set, and
wherein the pulsation device is configured for adapting the pulsation frequency and/or the pulsation pressure amplitude of the pulsation to one of the inherent resonance frequencies of the resonator, so that the selected resonance state can be achieved.

2. The reactor system according to claim 1, wherein the pulsation device is configured as a pulsation device that works without a flame.

3. The reactor system according to claim 1, wherein the reactor system has a heating device for heating the process gas.

4. (canceled)

5. The reactor system according to claim 1, wherein the pressure loss production devices are arranged in the process gas feed unit and the process gas discharge unit, in their corresponding position in the operating state, in an unchangeable manner.

6. The reactor system according to claim 1, wherein the pulsation device is configured as a pressure loss production device.

7. The reactor system according to claim 1, wherein a process gas volume stream regulation device is arranged upstream from the at least one reactor.

8. The reactor system according to claim 7, wherein the process gas volume stream regulation device is arranged downstream from the pulsation device.

9. The reactor system according to claim 7, wherein the process gas volume stream regulation device is configured as a sliding gate valve, regulating valve, regulating cock or an iris shutter that can be regulated.

10. The reactor system according to claim 7, wherein the process gas volume stream regulation device has a regulation precision of less than or equal to 3%.

11. The reactor system according to claim 1, wherein a process gas stream divider device is arranged upstream from the at least one reactor, so that at least one process gas feed line is assigned to each reactor of the reactor unit.

12-15. (canceled)

16. The reactor system according to claim 1, wherein the process gas feed unit and the process gas discharge unit have a process gas pressure regulation device, so that the static process gas pressure in the reactor system can be regulated.

17. The reactor system according to claim 1, wherein the process as discharge device has a plurality of process gas discharge lines, wherein each process gas discharge line has a pressure loss production device.

18. The reactor system according to claim 1, wherein the pulsation device is configured as a compression module or as a rotary vane or as a modified turnstile.

19. (canceled)

20. A method for the production and/or treatment of particles in an oscillating process gas stream using a reactor system having comprising a reactor unit that has an upstream process gas feed unit and a downstream process gas discharge unit, which reactor unit has at least one reaction space for particle production and/or treatment and an application device for introducing a starting substance into the reactor that comprises the reaction space,
wherein the process gas that flows through the reactor unit in the direction of the process gas discharge unit is fed to the reactor unit by way of the process gas feed unit, and the reactor system comprises a pulsation device that is suitable for the production of a pulsation of a process gas, wherein a pulsation that has a pulsation frequency and a pulsation pressure amplitude is imposed on the process gas by means of the pulsation device, and wherein the reactor system, which has a static process gas pressure, is configured as an acoustic resonator that has inherent resonance frequencies that define a resonance state, in each instance, and the process gas forms a gas column capable of resonance in the reactor system, so that the resonator is excited by means of the pulsation generated by the pulsation frequency and/or the pulsation pressure amplitude that is/are generated by the pulsation device, and in the resonance state, the pulsation is amplified to produce a resonance oscillation of the process gas that has a resonance frequency and a resonance pressure amplitude, and wherein the process gas feed unit and the process gas discharge unit each comprise a pressure loss production device that produces a pressure loss, wherein the pressure loss production devices are configured in such a manner that one of the resonance states can be optionally set, wherein the pulsation frequency and/or the pulsation pressure amplitude of the pulsation is adapted to one of the inherent resonance frequencies of the resonator by means of the pulsation device, so as to achieve the selected resonance state.

21. The method according to claim 20, wherein a periodic pulsation is imposed on the process gas.

22. The method according to claim 20, wherein the pulsation frequency or a whole-number multiple of it is set close to the resonance frequency of the resonator.

23. (canceled)

24. (canceled)

25. The method according to claim 20, wherein a pulsation frequency from 1 Hz to 2000 Hz is imposed on the process gas by means of the pulsation device.

26. The method according to claim 20, wherein a pulsation pressure amplitude from 0.1 mbar to 350 mbar is imposed on the process gas by means of the pulsation device.

27. The method according to claim 20, wherein a pulsation frequency from 40 Hz to 160 Hz and a pulsation pressure amplitude from 10 mbar to 40 mbar is imposed on the process gas by means of the pulsation device.

28. The method according to claim 20, wherein the pressure loss production devices, in the operating state, are not changed in terms of their respective positions.

29-30. (canceled)
